(19) United States
(12) Patent Application Publication
(10) Pub. No.: US 2017/0180052 A1
(43) Pub. Date: Jun. 22, 2017

(54) TRANSMISSION DEVICE AND PHASE ADJUSTMENT METHOD

(71) Applicant: FUJITSU LIMITED, Kawasaki-shi (JP)

(72) Inventors: Tatsuro Kishida, Fukuoka (JP); Koji BATO, Fukuoka (JP); Tomoyuki SAKATA, Fukuoka (JP); Eri KATAYAMA, Fukuoka (JP); Yu ETO, Fukuoka (JP)

(73) Assignee: FUJITSU LIMITED, Kawasaki-shi (JP)

(21) Appl. No.: 15/367,985

(22) Filed: Dec. 2, 2016

(30) Foreign Application Priority Data
Dec. 16, 2015 (JP) 2015-245672

(51) Int. Cl. H04B 10/548; H04Q 11/00; H04B 10/564

(52) U.S. Cl. CPC H04B 10/548; H04B 10/564; H04Q 11/0066

(57) ABSTRACT

A transmission device includes a first optical modulator configured to modulate, based on a packet signal for each of packets, input light into an optical packet signal and to output an optical packet signal for each of the packets; a generation circuit configured to generate an adjustment signal that adjusts slopes of a rise and a fall of a waveform of the optical packet signal; and a second optical modulator configured to modulate the optical packet signal from the first optical modulator and adjust, based on the adjustment signal, the slopes of the rise and the fall of the waveform of the optical packet signal.

### CROSS-REFERENCE TO RELATED APPLICATION

This application is based upon and claims the benefit of priority of the prior Japanese Patent Application No. 2015-245672, filed on Dec. 16, 2015, the entire contents of which are incorporated herein by reference.

### FIELD

The embodiments discussed herein are related to a transmission device and a phase adjustment method.

### BACKGROUND

For example, an optical path transmission device is a transmission device that uses a wavelength division multiplex (WDM) line to transmit an optical path signal.

However, in the wavelength division multiplex (WDM) line, because the refractive index of an optical fiber changes due to the changes in light intensities of a subject wavelength and other wavelengths by self phase modulation (SPM) and cross phase modulation (XPM), for example, phase modulation of the optical path signal occurs.

As a result, the transmission characteristics of the optical path signal degrade due to the phase modulation.

Accordingly, as a method of reducing the phase modulation of the optical path signal, a function has been known that reduces the steepness of slopes of a rise (Tr) and a fall (Tf) of an optical signal wave in the optical path signal and may thereby reduce the phase modulation of the optical path signal.

The optical path signals transmitted by the optical path transmission device have characteristics that those are temporally continuous signals and have fixed destinations.

As a result, in the optical path transmission device, the destination is fixed, and the parameters for reducing the steepness of the slopes of Tr and Tf of the optical path signal are thus fixed. Accordingly, processing thereof is easy.

Thus, in the optical path transmission device, the steepness of the slopes of Tr and Tf of the optical signal wave in the optical path signal is reduced, and the phase modulation of the optical path signal may thereby be reduced.

Further, an optical packet transmission device is a transmission device that uses the WDM line to transmit an optical packet signal.

The optical packet signals have characteristics that those are temporally burst signals and have different destinations.

The signal characteristics are different between the optical packet signal and the optical path signal.

Japanese Laid-open Patent Publication No. 2004-198461 and Japanese Laid-open Patent Publication No. 2009-213160 are examples of related art.

In an optical packet transmission device, it is possible that a method of reducing phase modulation of an optical path signal is applied and the steepness of slopes of Tr and Tf of an optical signal wave in an optical packet signal may thereby be reduced.

However, in the optical packet transmission device, the destination may be different among each of the optical packet signals, so a transmission path to the destination may be different among each of the optical packet signals. Thus, the parameters for reducing the steepness of the slopes of Tr and Tf of the optical signal wave in the optical packet signal are largely different.

Accordingly, in the optical packet transmission device, it is difficult to simply apply the method of reducing the steepness of the slopes of Tr and Tf for the optical path transmission device.

As a result, in the optical packet transmission system, the cross phase modulation of the optical packet signals that correspond to different transmission paths may not be reduced, and degradation of transmission characteristics may thus not be reduced.

It is desirable to provide a transmission device and a phase adjustment method that may reduce the phase modulation of the optical packet signals.

### SUMMARY

According to an aspect of the embodiments, a transmission device includes a first optical modulator configured to modulate, based on a packet signal for each of packets, input light into an optical packet signal and to output an optical packet signal for each of the packets; a generation circuit configured to generate an adjustment signal that adjusts slopes of a rise and a fall of a waveform of the optical packet signal; and a second optical modulator configured to modulate the optical packet signal from the first optical modulator and adjust, based on the adjustment signal, the slopes of the rise and the fall of the waveform of the optical packet signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A and FIG. 1B illustrate one example of an optical transmission system of a first embodiment;

FIG. 2 is an explanatory diagram that illustrates one example of a table configuration in a control voltage table;

FIG. 3 is an explanatory diagram that illustrates one example of decomposition and assembly of packet signals;

FIG. 4 is an explanatory diagram that illustrates one example of output timings of the packet signal, decomposed data, and optical packet signals;

FIG. 5 is an explanatory diagram that illustrates examples of configurations of an E/O converter and an optical waveform shaper in a first MDL;

FIG. 6A is an explanatory diagram that illustrates examples of the optical packet signal of a third waveguide, the optical packet signal (with no application of a control voltage signal) of a fourth waveguide, and an electric field intensity waveform (with no optical phase difference) of a combined optical packet signal in the optical waveform shaper;

FIG. 6B is an explanatory diagram that illustrates examples of the optical packet signal of the third waveguide, the optical packet signal (with application of a control voltage signal) of the fourth waveguide, and the electric field intensity waveform (with an optical phase difference) of a combined optical packet signal in the optical waveform shaper;

FIG. 7 is an explanatory diagram that illustrates examples of the optical packet signals which are yet to be input, control voltage signals, the optical packet signals whose optical phases have been adjusted, and the optical packet signals resulting from optical multiplexing in the optical waveform shaper;

FIG. 8 is a flowchart that illustrates one example of a processing operation of a transmission device which is related to an adjustment process;

FIG. 9 is a flowchart that illustrates one example of a processing operation of a setting circuit which is related to a setting process;

FIG. 10 is an explanatory diagram that illustrates one example of a configuration of an MDL of a second embodiment; and

FIG. 11 is an explanatory diagram that illustrates one example of a configuration of an optical modulator.

### DESCRIPTION OF EMBODIMENTS

Embodiments of a transmission device and an optical phase adjustment method that are disclosed by the present application will hereinafter be described in detail with reference to drawings.

The techniques of the present disclosure are not limited by the embodiments.

Further, the embodiments described below may appropriately be combined in the scope in which a contradiction does not occur.

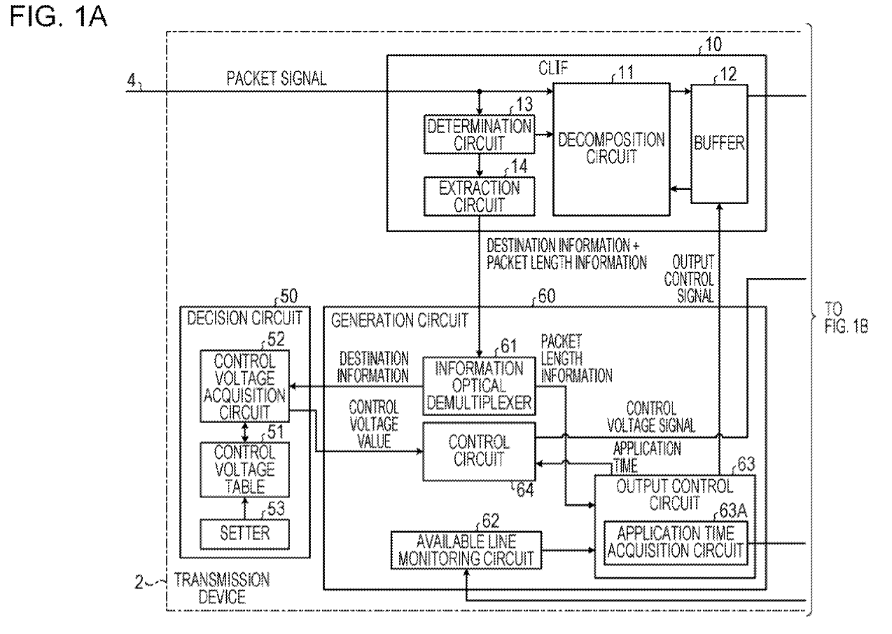

FIG. 1A and FIG. 1B illustrate one example of an optical transmission system 1 of a first embodiment.

The optical transmission system 1 illustrated in FIGS. 1A and 1B is an optical packet transmission system that is configured by connecting plural transmission devices 2 such as optical packet transmission devices which transmit temporally burst optical packet signals together by a wavelength division multiplexer (WDM) ring line 3, for example.

The optical packet signals have characteristics that those are temporally burst signals and have different destinations and packet lengths compared to an optical path signal which has a fixed destination and is temporally continuous, for example.

The transmission device 2 performs parallel processing of the optical packet signals, divides the optical packet signals into plural optical wavelengths, and transmits those in order to improve line usage efficiency by shortening a line occupancy time in a case of transmitting the optical packet signals on the WDM ring line 3.

The transmission device 2 has a client interface (CLIF) 10, plural modules (MDLs) 20, an optical switch 30, a line IF 40, a decision circuit 50, and a generation circuit 60.

For convenience of description, as for the CLIF 10 and the MDL 20, a function of transmitting the optical packet signal from the client (CL) line 4 to the WDM ring line 3 will be exemplified. However, it goes without saying that a function of transmission from the WDM ring line 3 to the CL line 4 is also provided.

The CLIF 10 is a communication IF that conducts the communication with the CL line 4.

The CLIF 10 has a decomposition circuit 11, a buffer 12, a determination circuit 13, and an extraction circuit 14.

The decomposition circuit 11 is a processing circuit that decomposes a packet signal into plural decomposed data for the parallel processing of the packet signal from the CL line 4.

The decomposition circuit 11 decomposes the packet signal into the decomposed data that are allocated to each optical wavelength λ in the WDM ring line 3.

The buffer 12 is an area that temporarily stores the decomposed data resulting from the decomposition by the decomposition circuit 11.

The decomposition circuit 11 and the buffer 12 are a division circuit that performs time division of the packet signal into the optical wavelengths in the WDM ring line 3, for example.

The determination circuit 13 determines whether or not the packet signal from the CL line 4 is present.

The extraction circuit 14 extracts destination information and packet length information from header information of the packet signal from the CL line 4.

The destination information is information that indicates the destination of the packet signal.

The packet length information is information that indicates the signal length of the packet signal.

The plural MDLs 20 are optical modules that convert the decomposed data stored in the buffer 12 into the optical packet signals of the optical wavelengths λ of used lines in the WDM ring line 3.

The MDLs 20 are a first MDL 20A to an Xth MDL 20X.

Each of the MDLs 20 has a laser diode (LD) 21, an E/O circuit 22, an E/O converter 23, a shaping circuit 24, and an optical waveform shaper 25.

The LD 21 inputs continuous wave (CW) light with the optical wavelength λ of a narrow band that is specified to each of the MDLs 20 to the E/O converter 23.

The E/O circuit 22 is a driver that drives and controls the E/O converter 23.

The E/O circuit 22 inputs the decomposed data that are stored in the buffer 12 and allocated to each of the optical wavelengths λ to the E/O converter 23.

The E/O converter 23 is a ferroelectric modulator such as a lithium niobate modulator (LN modulator) of a Mach-Zehnder type, for example, which performs optical conversion of the decomposed data from the E/O circuit 22 into the optical packet signal by the CW light from the LD 21.

The shaping circuit 24 is an adjustment signal generation circuit that applies a control voltage signal, which is an adjustment signal and will be described later, to the optical packet signal which is transmitted through the optical waveform shaper 25, for example.

The optical waveform shaper 25 is a ferroelectric modulator such as the LN modulator of the Mach-Zehnder type, for example.

The optical waveform shaper 25 is a slope adjustment modulator, for example.

The optical waveform shaper 25 has a third waveguide 25A and a fourth waveguide 25B, which will be described later, and performs optical branching of the optical packet signal from the E/O converter 23 into the third waveguide 25A and the fourth waveguide 25B.

The third waveguide 25A transmits and outputs the optical packet signal resulting from the optical branching.

The fourth waveguide 25B applies the control voltage signal from the shaping circuit 24 to the optical packet signal resulting from the optical branching and thereby outputs the optical packet signal whose optical phase has been adjusted.

The optical packet signal that is an output of the fourth waveguide 25B is the optical packet signal whose optical phase has been adjusted and which has an optical phase difference compared to the optical packet signal that is an output of the third waveguide 25A.

The optical switch 30 is a switch that switches and outputs the optical packet signals between the MDLs 20 and the line IF 40.

The optical switch 30 has a switch MDL 31, a line monitoring circuit 32, and a switch control circuit 33.

The switch MDL 31 is a switch that switches and outputs the optical packet signals of the respective optical wavelengths λ between the MDLs 20 and the line IF 40.

The line monitoring circuit 32 monitors a line use situation of each of the optical wavelengths λ in the WDM ring line 3.

The switch control circuit 33 controls the switch MDL 31.

The line IF 40 is a communication IF that conducts the communication with the WDM ring line 3.

The line IF 40 has an optical multiplexer 41 and an optical demultiplexer 42.

The optical multiplexer 41 is, for example, an output section that performs combined output of the decomposed optical packet signals of the respective optical wavelengths λ to the WDM ring line 3.

The optical demultiplexer 42 performs demultiplexed input of the optical packet signals that are received from the WDM ring line 3.

The line monitoring circuit 32 monitors a line situation of each of the optical wavelengths λ in the WDM ring line 3 from the optical demultiplexer 42.

The decision circuit 50 is a processing circuit that decides the control voltage value of the control voltage signal which is applied to the optical waveform shaper 25.

The decision circuit 50 has a control voltage table 51, a control voltage acquisition circuit 52, and a setting circuit 53.

The control voltage table 51 is a table that stores control voltage values which are set for respective pieces of destination information of the packet signals.

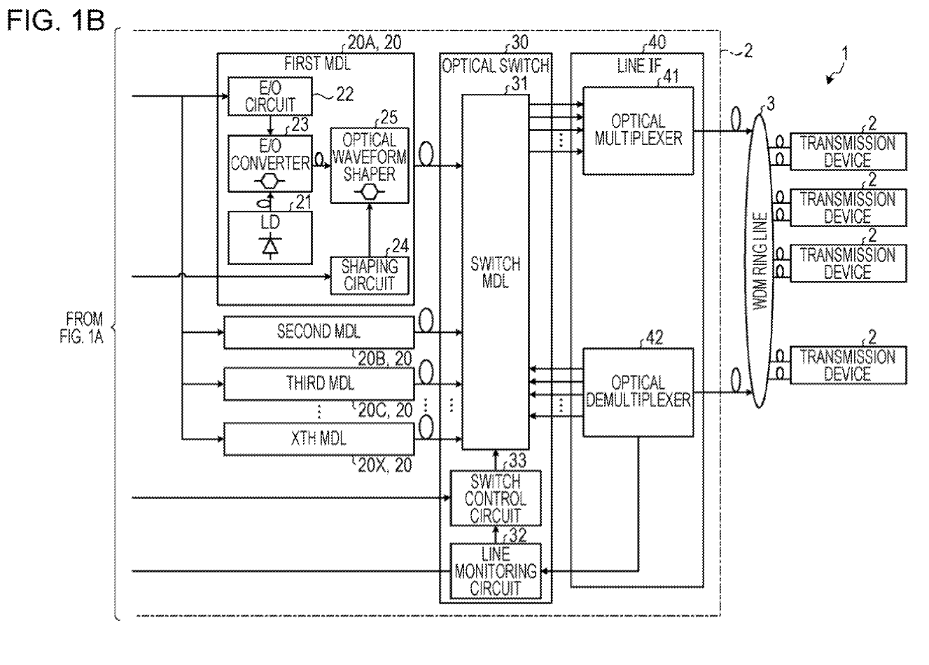

FIG. 2 is an explanatory diagram that illustrates one example of a table configuration in the control voltage table 51.

The control voltage table 51 illustrated in FIG. 2 is a table that stores an optical wavelength 51B used in the WDM ring line 3 and a control voltage value 51C which are associated with each other with respect to each piece of destination information 51A.

The control voltage acquisition circuit 52 is, for example, an acquisition circuit that acquires the control voltage value for each of the optical wavelengths λ which corresponds to the destination information from the control voltage table 51.

The control voltage acquisition circuit 52 then notifies the generation circuit 60 of the acquired control voltage value.

The setting circuit 53 sets and registers the voltage value of the optical wavelength λ with respect to each of the pieces of destination information in the control voltage table 51.

The setting circuit 53 uses a test optical packet signal under the communication environment of the transmission path that corresponds to the destination information and thereby acquires a lower limit voltage value and an upper limit voltage value of each of the optical wavelengths λ.

In addition, the setting circuit 53 specifies an arbitrary voltage value for each of the optical wavelengths λ from the voltage range between the lower limit voltage value and the upper limit voltage value with respect to each of the optical wavelengths λ and registers the specified arbitrary voltage value as the control voltage value in the control voltage table 51.

The control voltage values for the same destination information are specified so as to be different among each of the optical wavelengths λ.

The generation circuit 60 is a processing circuit that controls an output timing of the packet signal in accordance with the line use situation of the optical wavelength λ which is used in the WDM ring line 3, for example.

The generation circuit 60 has an information optical demultiplexer 61, an available line monitoring circuit 62, an output control circuit 63, and a control circuit 64.

The information optical demultiplexer 61 decomposes information from the extraction circuit 14 into the destination information and the packet length information.

The available line monitoring circuit 62 monitors an available situation of an optical line of each of the optical wavelengths λ in the WDM ring line 3 based on monitoring results from the line monitoring circuit 32.

The output control circuit 63 controls the output timing of the buffer 12 in order to output the decomposed data that correspond to the optical wavelength λ in an available state in a case where the optical line of the optical wavelength λ to be used is in the available state, based on the monitoring results of the available line monitoring circuit 62.

The output control circuit 63 has an application time acquisition circuit 63A.

In a case where the application time acquisition circuit 63A acquires the packet length information from the information optical demultiplexer 61, the application time acquisition circuit 63A adds a shortest packet interval to the packet length of the decomposed data as an application target and thereby calculates the line occupancy time of the decomposed data in the WDM ring line 3.

The packet length of the decomposed data as the application target is the signal length that corresponds to the decomposed data allocated to each of the optical wavelengths λ.

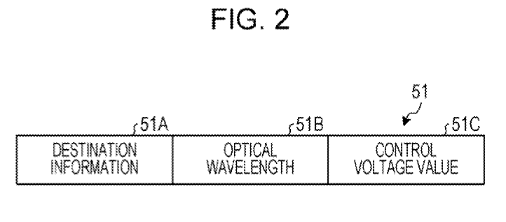

For example, the line occupancy time of the decomposed data P1-1, P1-5, and P1-9 that are allocated to an optical wavelength λ1 in a packet signal P1 illustrated in FIG. 3 is the packet lengths of the decomposed data P1-1, P1-5, and P1-9+the shortest packet interval σ 2.

The shortest packet interval÷2 is a margin of the application time that corresponds to the packet length and may thus be “0”.

The application time acquisition circuit 63A sets the line occupancy time as the application time of the control voltage signal and sets the application time for the control circuit 64.

The control circuit 64 generates the control voltage signal based on the control voltage value that is acquired by control voltage acquisition circuit 52 and the application time that is acquired by the application time acquisition circuit 63A.

The control circuit 64 sets, for the shaping circuit 24, the control voltage signal to be applied to the optical packet signal that passes through the fourth waveguide 25B in the optical waveform shaper 25 in each of the MDLs 20.

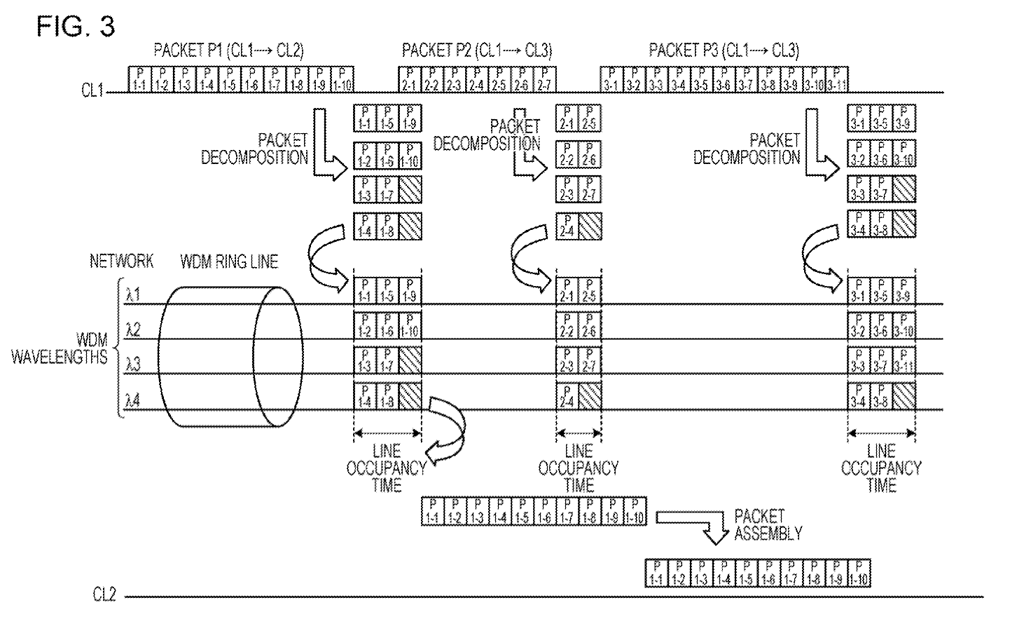

FIG. 3 is an explanatory diagram that illustrates one example of decomposition and assembly of the packet signals. FIG. 4 is an explanatory diagram that illustrates one example of output timings of the packet signal, decomposed data, and optical packet signals.

For convenience of description, it is assumed that the packet signal P1 illustrated in FIG. 3 is the packet signal from a CL1 to a CL2 and a packet signal P2 is the packet signal from the CL1 to a CL3.

Further, it is assumed that a packet signal P3 is the packet signal from the CL1 to the CL3.

It is assumed that the CL1 is a CL on the CL line 4 side and the CL2 and the CL3 are the CLs on the sides of CL lines that are connected with the other transmission devices 2 connected with WDM ring line 3.

The packet signal P1, the packet signal P2, and the packet signal P3 are input in this order from the CL line 4 to the decomposition circuit 11.

The decomposition circuit 11 decomposes the packet signal P1 into decomposed data P1-1 to P1-10.

For example, among optical wavelengths λ1, λ2, λ3, and λX, the decomposition circuit 11 sequentially allocates the decomposed data P1-1 to the optical wavelength λ1, the next decomposed data P1-2 to the optical wavelength λ2, the next decomposed data P1-3 to the optical wavelength λ3, and the next decomposed data P1-4 to the optical wavelength λX and sequentially stores those decomposed data P1-1 to P1-4 in the buffer 12.

In addition, the decomposition circuit 11 sequentially allocates the decomposed data P1-1, P1-5, and P1-9 to the optical wavelength λ1, the decomposed data P1-2, P1-6, and P1-10 to the optical wavelength λ2, the decomposed data P1-3 and P1-7 to the optical wavelength λ3, and the decomposed data P1-4 and P1-8 to the optical wavelength λX.

Then, the decomposition circuit 11 sequentially stores those decomposed data P1-1 to P1-10 in the buffer 12.

For example, the first MDL 20A converts the decomposed data P1-1, P1-5, and P1-9 into the optical packet signal of the optical wavelength λ1.

The second MDL 20B converts the decomposed data P1-2, P1-6, and P1-10 into the optical packet signal of the optical wavelength λ2.

The third MDL 20C converts the decomposed data P1-3 and P1-7 into the optical packet signal of the optical wavelength λ3.

The Xth MDL 20X converts the decomposed data P1-4 and P1-8 into the optical packet signal of the optical wavelength λX.

In a case where the output control circuit 63 detects the available states of the optical lines of the optical wavelengths λ1, λ2, λ3, and λX of the WDM ring line 3, the output control circuit 63 controls the output of the buffer 12 in order to output the decomposed data P1-1, P1-5, and P1-9 to the first MDL 20A.

Further, the output control circuit 63 controls the output of the buffer 12 in order to output the decomposed data P1-2, P1-6, and P1-10 to the second MDL 20B, the decomposed data P1-3 and P1-7 to the third MDL 20C, and the decomposed data P1-4 and P1-8 to the Xth MDL 20X.

The first MDL 20A converts the decomposed data P1-1, P1-5, and P1-9 into the optical packet signal of the optical wavelength λ1 and outputs those to the optical switch 30.

The second MDL 20B converts the decomposed data P1-2, P1-6, and P1-10 into the optical packet signal of the optical wavelength λ2 and outputs those to the optical switch 30.

The third MDL 20C converts the decomposed data P1-3 and P1-7 into the optical packet signal of the optical wavelength λ3 and outputs those to the optical switch 30.

The Xth MDL 20X converts the decomposed data P1-4 and P1-8 into the optical packet signal of the optical wavelength λX and outputs those to the optical switch 30.

Then, the optical multiplexer 41 of the line IF 40 performs multiplexed output of the optical packet signal of the optical wavelength λ1 from the first MDL 20A to the line of the optical wavelength λ1 in the WDM ring line 3 and multiplexed output of the optical packet signal of the optical wavelength λ2 from the second MDL 20B to the line of the optical wavelength λ2.

Further, the optical multiplexer 41 performs multiplexed output of the optical packet signal of the optical wavelength λ3 from the third MDL 20C to the line of the optical wavelength λ3 and multiplexed output of the optical packet signal of the optical wavelength λX from the Xth MDL 20X to the line of the optical wavelength λX.

That is, the optical multiplexer 41 performs the multiplexed output of the optical packet signals of the optical wavelengths λ1, λ2, λ3, and λX at the same timing.

The optical packet signal from the first MDL 20A is the signal resulting from the optical conversion of the decomposed data P1-1, P1-5, and P1-9.

The optical packet signal from the second MDL 20B is the signal resulting from the optical conversion of the decomposed data P1-2, P1-6, and P1-10.

The optical packet signal from the third MDL 20C is the signal resulting from the optical conversion of the decomposed data P1-3 and P1-7.

The optical packet signal from the Xth MDL 20X is the signal resulting from the optical conversion of the decomposed data P1-4 and P1-8.

Further, the decomposition circuit 11 similarly decomposes the packet signal P2 and the packet signal P3 and stores the decomposed data of the packet signals in the buffer 12.

In addition, the output control circuit 63 controls the output of the buffer 12 in order to sequentially output the decomposed data that are stored in the buffer 12 to the MDLs 20 of the respective optical wavelengths λ based on a line available situation of the WDM ring line 3.

Further, the other transmission device 2 connected with the CL2 sequentially extracts optical packet signals P1-1 to P1-10 of the optical wavelengths λ1, λ2, λ3, and λX of the CL2 from the WDM ring line 3 and assembles the optical packet signal P1 from those extracted optical packet signals P1-1 to P1-10.

Further, the other transmission device 2 connected with the CL3 sequentially extracts optical packet signals P2-1 to P2-7 of the respective optical wavelengths λ of the CL3 from the WDM ring line 3 and assembles the optical packet signal P2 from those extracted optical packet signals P2-1 to P2-7.

Further, the other transmission device 2 connected with the CL3 sequentially extracts optical packet signals P3-1 to P3-11 of the respective optical wavelengths λ of the CL3 from the WDM ring line 3 and assembles the optical packet signal P3 from those extracted optical packet signals P3-1 to P3-11.

It is assumed that the transmission device 2 has to receive the optical packet signals of the respective optical wavelengths at the same timing in consideration of assembling the optical packet signals on the reception side and thus transmits the optical packet signals at the same timing.

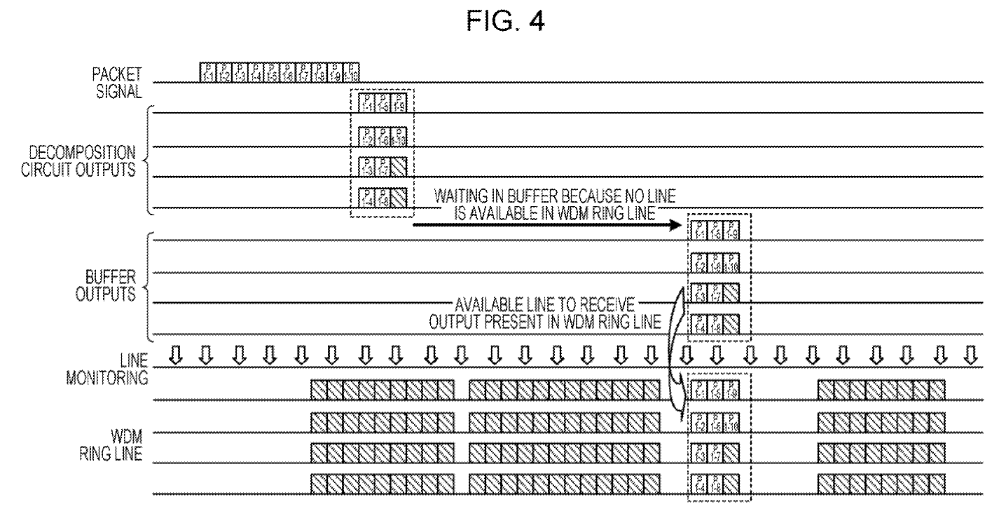

FIG. 5 is an explanatory diagram that illustrates examples of configurations of the E/O converter 23 and the optical waveform shaper 25 in the first MDL 20A.

For convenience of description, the first MDL 20A will be exemplified. However, the second MDL 20B, the third MDL 20C, and the Xth MDL 20X have the same configuration as the first MDL 20A, and descriptions of configurations and operations thereof will thus not be made.

The E/O converter 23 in the first MDL 20A has a first waveguide 23A and a second waveguide 23B and performs optical branching of the CW light from the LD 21 into the first waveguide 23A and the second waveguide 23B.

The E/O circuit 22 applies the decomposed data (data patterns) P1-1, P1-5, and P1-9 to the CW light that passes through the first waveguide 23A and the second waveguide 23B.

As a result, the E/O converter 23 performs optical conversion into the optical packet signals P1-1, P1-5, and P1-9 by the first waveguide 23A and the second waveguide 23B.

The E/O converter 23 combines the optical packet signals that are outputs of the first waveguide 23A and the optical packet signals that are outputs of the second waveguide 23B and outputs the combined optical packet signals to the optical waveform shaper 25.

The optical waveform shaper 25 has the third waveguide 25A and the fourth waveguide 25B and performs optical branching of the optical packet signal from the E/O converter 23 into the third waveguide 25A and the fourth waveguide 25B.

The third waveguide 25A transmits the optical packet signal resulting from the optical branching.

The fourth waveguide 25B applies the control voltage signal that corresponds to the application time to the optical packet signal resulting from the optical branching and outputs the optical packet signal to which the control voltage signal is applied, that is, the optical packet signal whose optical phase has been adjusted.

An optical phase difference occurs between the optical packet signal that is the output of the fourth waveguide 25B and the optical packet signal that is the output of the third waveguide 25A.

The optical waveform shaper 25 then outputs the optical packet signal which results from combining of the optical packet signal as the output of the third waveguide 25A and the optical packet signal with the adjusted optical phase as the output of the fourth waveguide 25B and in which an optical phase interference occurs.

As a result, as illustrated in FIG. 5, the steepness of the slopes of Tr and Tf of an optical signal wave is reduced in the optical signal wave of the optical packet signal whose optical phase has been adjusted.

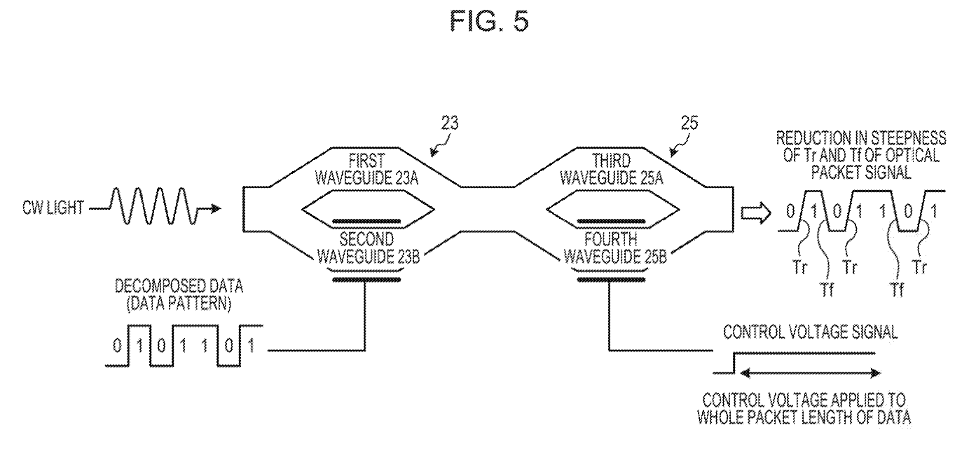

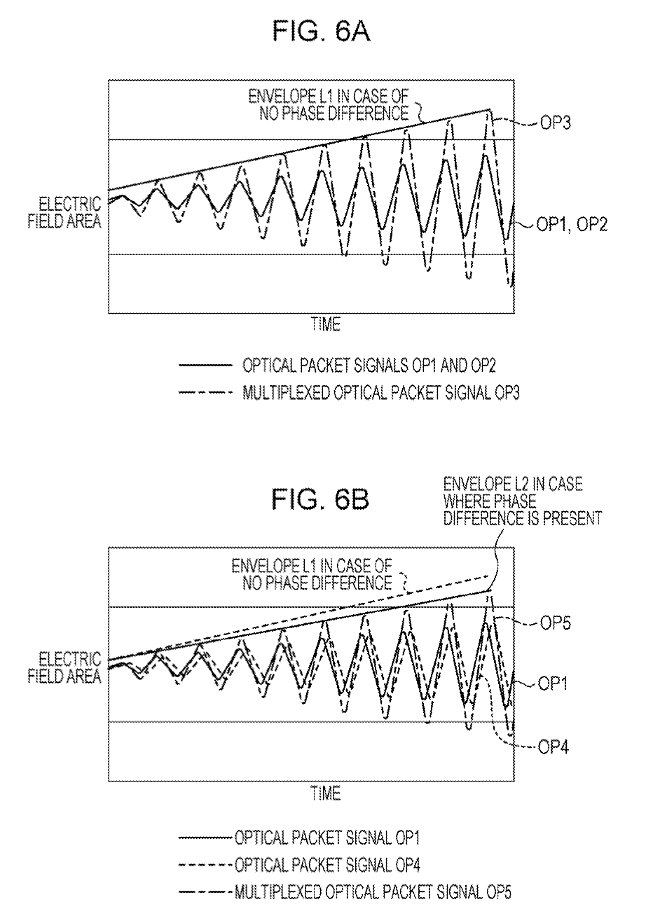

FIG. 6A is an explanatory diagram that illustrates examples of an optical packet signal OP1 of the third waveguide 25A, an optical packet signal (with no application of the control voltage signal) OP2 of the fourth waveguide 25B, and the electric field intensity waveform (with no optical phase difference) of a combined optical packet signal OP3 in the optical waveform shaper 25.

The optical waveform shaper 25 combines the optical packet signal OP1 that is the output of the third waveguide 25A and the optical packet signal OP2 that is the output of the fourth waveguide 25B and outputs the combined optical packet signal OP3.

An envelope L1 of the combined optical packet signal OP3 is illustrated in FIG. 6A.

FIG. 6B is an explanatory diagram that illustrates examples of the optical packet signal OP1 of the third waveguide 25A, an optical packet signal (with application of the control voltage signal) OP4 of the fourth waveguide 25B, and the electric field intensity waveform (with an optical phase difference) of a combined optical packet signal OP5 in the optical waveform shaper 25.

The optical waveform shaper 25 combines the optical packet signal OP1 that is the output of the third waveguide 25A and the optical packet signal OP4 of the fourth waveguide 25B, to which the control voltage has been applied, and outputs the combined optical packet signal OP5.

An envelope L2 of the combined optical packet signal OP5 has a mild slope compared to the envelope L1.

As a result, the slope of the envelope becomes milder in a case where the optical phase difference is present, and the steepness of the slopes of Tr and Tf of the optical signal wave of the optical packet signal OP5 is thereby reduced.

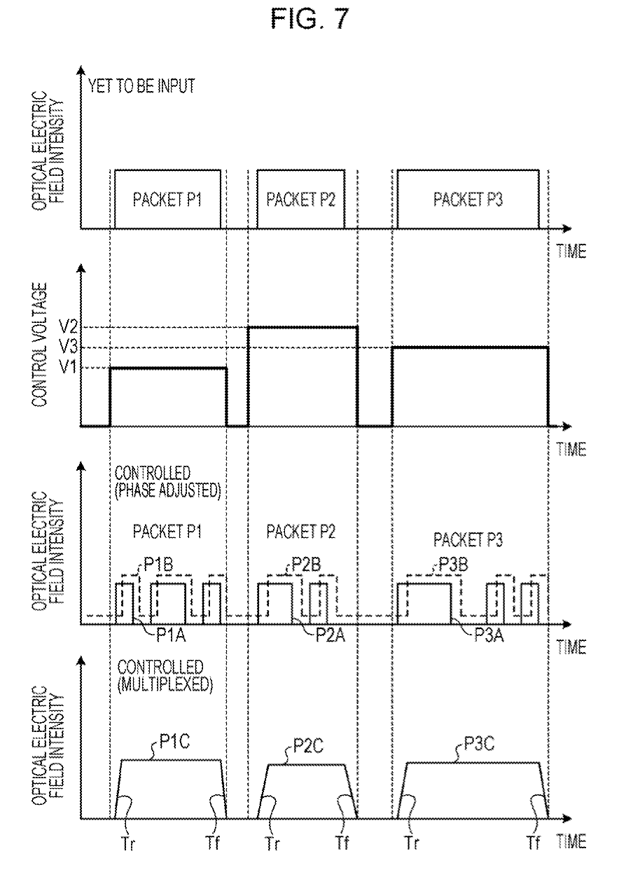

FIG. 7 is an explanatory diagram that illustrates examples of the optical packet signals P1 to P3 which are yet to be input, the control voltage signals, the optical packet signals P1 to P3 whose optical phases have been adjusted, and the optical packet signals P1 to P3 resulting from optical combining in the optical waveform shaper 25.

The optical packet signals P1, P2, and P3 have different destinations.

The optical waveform shaper 25 applies a control voltage signal V1 based on the destination information and the packet length information of the optical packet signal P1 to the optical packet signal P1 from the E/O converter 23.

In addition, the optical waveform shaper 25 outputs an optical packet signal P1A that is an output of the third waveguide 25A and an optical packet signal P1B as an output of the fourth waveguide 25B, to which the control voltage signal V1 has been applied, that is, whose optical phase has been adjusted.

The optical waveform shaper 25 combines the optical packet signal P1A and the optical packet signal P1B whose optical phase has been adjusted and outputs a combined optical packet signal P1C.

The combined optical packet signal P1C is in a state where the steepness of the slopes of Tr and Tf is reduced.

Further, the optical waveform shaper 25 applies a control voltage signal V2 based on the destination information and the packet length information of the optical packet signal P2 to the optical packet signal P2 from the E/O converter 23.

In addition, the optical waveform shaper 25 outputs an optical packet signal P2A that is an output of the third waveguide 25A and an optical packet signal P2B as an output of the fourth waveguide 25B, to which the control voltage signal V2 has been applied, that is, whose optical phase has been adjusted.

The optical waveform shaper 25 combines the optical packet signal P2A and the optical packet signal P2B whose optical phase has been adjusted and outputs a combined optical packet signal P2C.

The combined optical packet signal P2C is in a state where the steepness of the slopes of Tr and Tf is reduced.

Further, the optical waveform shaper 25 applies a control voltage signal V3 based on the destination information and the packet length information of the optical packet signal P3 to the optical packet signal P3 from the E/O converter 23.

In addition, the optical waveform shaper 25 outputs an optical packet signal P3A that is an output of the third waveguide 25A and an optical packet signal P3B as an output of the fourth waveguide 25B, to which the control voltage signal V3 has been applied, that is, whose optical phase has been adjusted.

The optical waveform shaper 25 combines the optical packet signal P3A and the optical packet signal P3B whose optical phase has been adjusted and outputs a combined optical packet signal P3C.

The combined optical packet signal P3C is in a state where the steepness of the slopes of Tr and Tf is reduced.

A description will next be made about an operation of the optical transmission system 1 of the first embodiment.

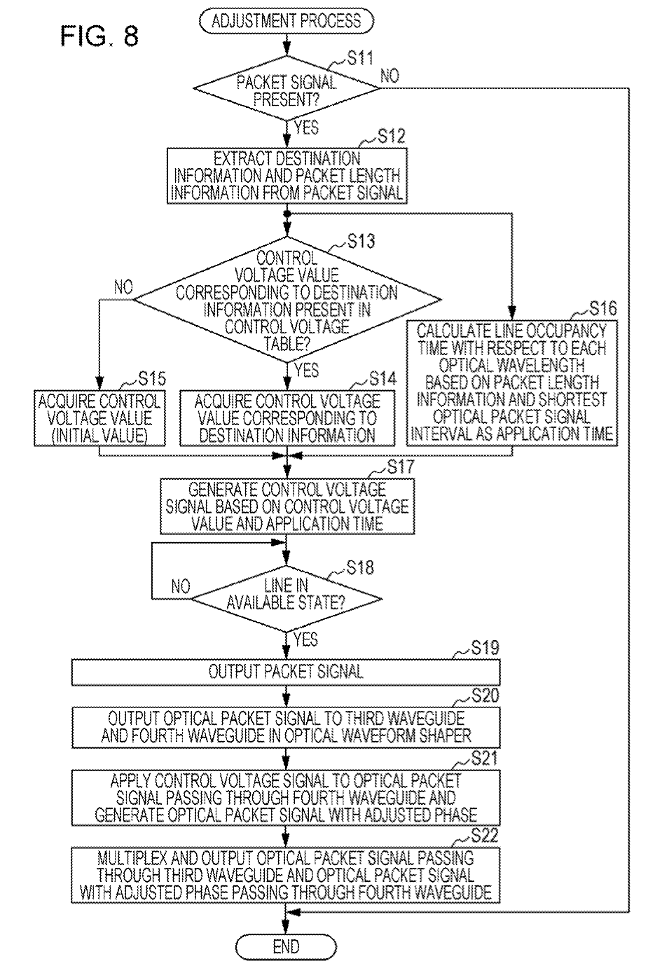

FIG. 8 is a flowchart that illustrates one example of a processing operation of the transmission device 2 which is related to an adjustment process.

The adjustment process illustrated in FIG. 8 is a process for reducing the steepness of the slopes of Tr and Tf of the optical signal wave in the optical packet signal by the optical phase interference between the same optical packet signals with respect to each of the optical packet signals.

In FIG. 8, the determination circuit 13 in the transmission device 2 determines whether or not the packet signal from the CL line 4 is present (step S11).

In a case where the packet signal is present (Yes in step S11), the extraction circuit 14 in the transmission device 2 extracts the destination information and the packet length information from the header information of the packet signal (step S12).

In a case where the destination information and the packet length information are extracted in step S12, the transmission device 2 executes processing operations of step S13 and step S16, which will be described later.

The decomposition circuit 11 decomposes the packet signal from the CL line 4 and stores the decomposed data from the decomposition in the buffer 12.

The control voltage acquisition circuit 52 in the transmission device 2 determines whether or not the control voltage value that corresponds to the acquired destination information is present in the control voltage table 51 (step S13).

In a case where the control voltage value that corresponds to the destination information is present (Yes in step S13), the control voltage acquisition circuit 52 acquires the control voltage value that corresponds to the destination information and sets the acquired control voltage value for the control circuit 64 (step S14).

Further, in a case where the control voltage value that corresponds to the destination information is not present (No in step S13), the control voltage acquisition circuit 52 acquires the control voltage value that is an initial value and sets the acquired control voltage value for the control circuit 64 (step S15).

Further, the application time acquisition circuit 63A in the transmission device 2 calculates the line occupancy time that corresponds to the decomposed data of the optical wavelength λ of the optical packet signal based on the acquired packet length information and the shortest optical packet signal interval.

In addition, the application time acquisition circuit 63A sets the calculated line occupancy time as the application time for the control circuit 64 (step S16).

The packet length information corresponds to the signal length of the decomposed data of each of the optical wavelengths in a case where the decomposed data of the packet signal from the CL line 4 are allocated to four optical wavelengths, for example.

The control circuit 64 generates the control voltage signal to be applied to the optical waveform shaper 25 of the MDL 20 that corresponds to the optical wavelength λ based on the control voltage value and the application time (step S17).

The output control circuit 63 in the transmission device 2 determines whether or not the line of the optical wavelength λ that is used in the WDM ring line 3 is in the available state via the available line monitoring circuit 62 (step S18).

The output control circuit 63 makes a determination about the available state of the line of the optical wavelength λ that is used for transmission of the optical packet signal related to the decomposed data.

In a case where the line of the optical wavelength λ that is used for transmission of the optical packet signal is in the available state (Yes in step S18), the output control circuit 63 outputs the decomposed data of the optical wavelength λ from the buffer 12 to the E/O converter 23 in the MDL 20 that corresponds to each of the optical wavelengths λ (step S19).

The E/O converter 23 performs optical conversion of the decomposed data from the buffer 12 and outputs the optical packet signal.

The optical waveform shaper 25 in the transmission device 2 performs optical branching of the optical packet signal from the E/O converter 23 and outputs the optical packet signal resulting from the optical branching to the third waveguide 25A and the fourth waveguide 25B (step S20).

The control circuit 64 applies the control voltage signal to the optical packet signal that passes through the fourth waveguide 25B (step S21).

Then, because the control voltage signal is applied to the optical packet signal that passes therethrough, the refractive index of the optical packet signal as the output of the fourth waveguide 25B changes in the fourth waveguide 25B, an optical phase delay thereby occurs, and the optical packet signal whose optical phase has been adjusted is thus obtained.

The optical waveform shaper 25 combines the optical packet signal as the output of the third waveguide 25A and the optical packet signal with the adjusted optical phase as the output of the fourth waveguide 25B and outputs the combined optical packet signal to the optical line of the specified optical wavelength λ in the WDM ring line 3 (step S22).

Then, the optical waveform shaper 25 finishes the processing operation illustrated in FIG. 8.

In the combined optical packet signal, the steepness of the slopes of Tr and Tf in the optical packet signal is reduced, and the phase modulation of the optical packet signal may thereby be reduced.

The transmission device 2 generates the control voltage signals based on the control voltage values for the respective optical wavelengths λ for the respective pieces of destination information of the packet signals.

The transmission device 2 converts the decomposed data of the packet signal into the optical packet signal and performs optical branching of the optical packet signal into the third waveguide 25A and the fourth waveguide 25B.

The transmission device 2 applies the control voltage signal to the optical packet signal that passes through the fourth waveguide 25B and outputs the optical packet signal whose optical phase has been adjusted.

The transmission device 2 combines the optical packet signal of the third waveguide 25A and the optical packet signal of the fourth waveguide 25B, whose optical phase has been adjusted, and the steepness of the slopes Tr and Tf of the optical signal wave in the optical packet signal is thereby reduced.

As a result, the phase modulation of the optical packet signal may be reduced.

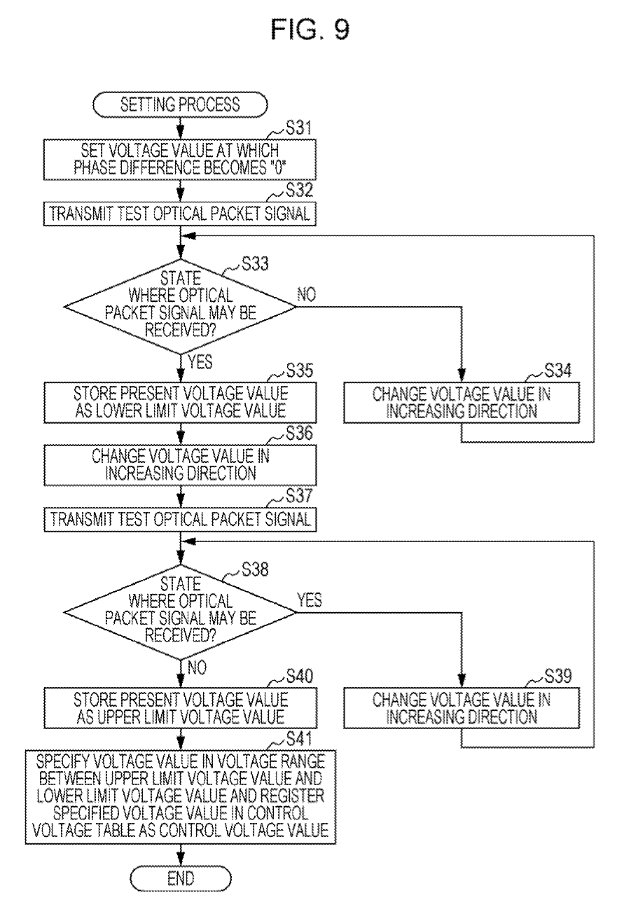

FIG. 9 is a flowchart that illustrates one example of a processing operation of the setting circuit 53 which is related to a setting process.

The setting process illustrated in FIG. 9 is a process in which the voltage ranges for the optical wavelengths λ are decided for the respective pieces of destination information by using test optical packet signals and arbitrary voltage values in the voltage ranges are registered as the control voltage values in the control voltage table 51.

The setting circuit 53 specifies the communication environment of the transmission path of the destination information of a setting target, for example, a transmission distance and optical fiber conditions (a dispersion coefficient, non-linear characteristics, and so forth) and specifies the MDL 20 to be used for each of the optical wavelengths λ.

The setting process is a process that is executed in a network construction of the optical transmission system 1.

The setting circuit 53 sets the control voltage signal at the voltage value at which the optical phase difference between the optical packet signal as the output of the third waveguide 25A and the optical packet signal as the output of the fourth waveguide 25B becomes “0” (step S31).

The setting circuit 53 specifies the communication environment of the transmission path of the destination information of the setting target and sets the control voltage signal at the voltage value at which the optical phase difference becomes “0” in the transmission path.

The setting circuit 53 sets an input of the test optical packet signal to the optical waveform shaper 25 for the E/O converter 23 (step S32) and determines whether or not a state where the optical packet signal may be received is provided (step S33).

The reference for the determination of whether or not the state where the optical packet signal may be received is provided is whether or not a bit error rate (BER) of the optical packet signal is less than a prescribed threshold value.

In a case where the state where the optical packet signal may be received is not provided (No in step S33), the setting circuit 53 changes the setting of the voltage value in an increasing direction (step S34) and moves to step S33 in order to determine whether or not the state where the optical packet signal may be received is provided.

In a case where the state where the optical packet signal may be received is provided (Yes in step S33), the setting circuit 53 stores the present voltage value as the lower limit voltage value (step S35) and changes the setting of the voltage value in the increasing direction (step S36).

The setting circuit 53 sets the input of the test optical packet signal to the optical waveform shaper 25 for the E/O converter 23 (step S37) and determines whether or not a state where the present optical packet signal may be received is provided (step S38).

In a case where the state where the present optical packet signal may be received is provided (Yes in step S38), the setting circuit 53 further changes the setting of the voltage value in the increasing direction (step S39) and moves to step S38 in order to determine whether or not the state where the optical packet signal may be received is provided.

In a case where the state where the present optical packet signal may be received is not provided (No in step S38), the setting circuit 53 stores the present voltage value as the upper limit voltage value (step S40).

The setting circuit 53 sets the lower limit voltage value and the upper limit voltage value that are related to the corresponding optical wavelengths λ to the destination information of an examination target as the voltage range, registers an arbitrary voltage value in the voltage range as the control voltage value in the control voltage table 51 (step S41), and finishes the processing operation illustrated in FIG. 9.

The arbitrary voltage value in the voltage range may be specified by an operation by a user, for example.

As a result, the setting circuit 53 identifies the voltage range between the lower limit voltage value and the upper limit voltage value of one optical wavelength that corresponds to the destination information and registers an arbitrary voltage value in the voltage range as the control voltage value in the control voltage table 51.

As a result, the control voltage value for each of the optical wavelengths λ that corresponds to the destination information in the control voltage table 51 may be registered.

The transmission device 2 may reduce the phase modulation of the optical packet signals even in a case where the destinations are different without requesting a high-speed modulation process because the steepness of the slopes of Tr and Tf is reduced with respect to each of the optical packet signals.

As a result, the transmission device 2 may handle long distance transmission while reducing degradation of transmission characteristics by reducing the phase modulation of the optical packet signals.

The control voltage table 51 sets and registers a different control voltage value for each of the optical wavelengths λ in the same destination information and may thus reduce the phase modulation of the optical packet signals with high accuracy.

Optical path transmission devices may use a dispersion application method that applies a wavelength dispersion by using an optical fiber, a tunable dispersion compensator of a VIPA type, or the like and thereby reduces the steepness of the slopes of Tr and Tf of the optical signal wave in the optical path signal.

However, in the optical path transmission device, the destination of the optical path signal is fixed, and the applied dispersion amount is thus fixed.

On the other hand, in the optical packet transmission device, because the destination is different and the applied dispersion amount is different among each of the optical packet signals, the applied dispersion amount may not instantly be set.

Accordingly, the transmission device 2 reduces the steepness of the slopes of Tr and Tf of the optical signal wave in the optical packet signal of the optical wavelength λ with respect to each of the optical packet signals and may thus reduce the phase modulation of the optical packet signals with high accuracy.

Further, the optical path transmission devices may use a method of a pre-equalization process that generates an electric signal on which a control signal is superimposed at the stage of electric signal so as to reduce the steepness of the slopes of Tr and Tf of the optical signal wave in the optical path signal resulting from optical conversion.

However, in the optical path transmission device, the control signals perform control of the waveforms of the slopes of Tr and Tf only at change points of data patterns, that is, perform bitwise control. Thus, the process has to be performed at a higher rate than the bit rate of the data.

On the other hand, the transmission device 2 does not perform bitwise control but reduces the steepness of the slopes of Tr and Tf with respect to each of the optical packet signals and may thus reduce the phase modulation of the optical packet signals even in a case where the bit rate of the data becomes a higher rate.

The transmission device 2 performs optical branching of the optical packet signal into the third waveguide 25A and the fourth waveguide 25B in the optical waveform shaper 25 and adjusts the optical phase of the optical packet signal that passes through the fourth waveguide 25B based on the control voltage signal.

In addition, the transmission device 2 combines the optical packet signal with the adjusted optical phase as the output of the fourth waveguide 25B and the optical packet signal as the output of the third waveguide 25A and thereby reduces the steepness of the slopes Tr and Tf of the optical signal wave in the optical packet signal.

As a result, the phase modulation of the optical packet signal may be reduced.

The transmission device 2 extracts the destination information from the packet signal, acquires the control voltage value that corresponds to the extracted destination information from the control voltage table 51, and generates the control voltage signal based on the control voltage value.

As a result, the transmission device 2 may generate different control voltage signals for the respective pieces of destination information of the packet signals.

The transmission device 2 extracts the packet length information from the packet signal, calculates the application time of the control voltage signal for the optical packet signal based on the packet length information, and applies the control voltage signal based on the application time to the optical packet signal that passes through the fourth waveguide 25B.

As a result, the transmission device 2 may set a different control voltage signal and an application time for each of the packet signals.

In the above first embodiment, a different control voltage value is registered in the control voltage table 51 with respect to each of the optical wavelengths λ in the same destination information. However, embodiments are not limited to the different control voltage value, but the same control voltage value may be registered in the control voltage table 51 with respect to each of the optical wavelengths λ in the same destination information.

In the above first embodiment, the optical packet transmission device that transmits the optical packet signal is exemplified. However, similar effects may be obtained by applying the above first embodiment to the optical path transmission device that transmits the optical path signal.

In the above first embodiment, a parallel processing configuration is exemplified in which the decomposed data resulting from division of the packet signal are allocated to each of the optical wavelengths λ of the WDM ring line 3. However, embodiments are not limited to such a configuration, but modifications may appropriately be made.

In the setting process in the above first embodiment, in steps S33 and S38, a determination is made whether or not the state where the optical packet signal may be received is provided. However, a determination may be made whether or not the state where the optical packet signal may be received is provided based on the BER by an operation by the user.

As the E/O converter 23 in the above first embodiment, the LN modulator is exemplified, for example. However, the E/O converter 23 is not limited to the LN modulator but may be an electric field absorption type modulator (EA modulator), for example, and may appropriately be changed.

As the optical waveform shaper 25 in the above first embodiment, the LN modulator is exemplified, for example. However, the optical waveform shaper 25 may be an electro-optic modulator that performs phase modulation by using a phase difference by a change in the refractive index in the third waveguide 25A and the fourth waveguide 25B and may appropriately be changed.

The control voltage signal applied to the optical waveform shaper 25 in the above first embodiment adjusts the optical phase of the optical packet signal by voltage control. However, embodiments are not limited to the voltage control, but the optical phase of the optical packet signal may be adjusted by current control or temperature control, for example.

In each of the MDLs 20 in the above first embodiment, the E/O converter 23 and the optical waveform shaper 25 are respectively configured with separate optical modulators. However, the E/O converter 23 and the optical waveform shaper 25 may be configured with a single optical modulator. An embodiment in such a case will be described below as a second embodiment.

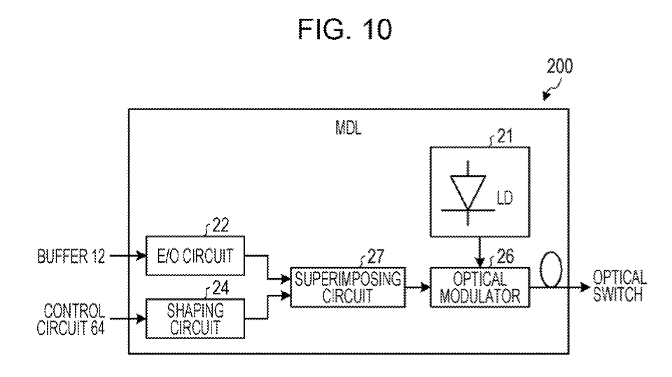

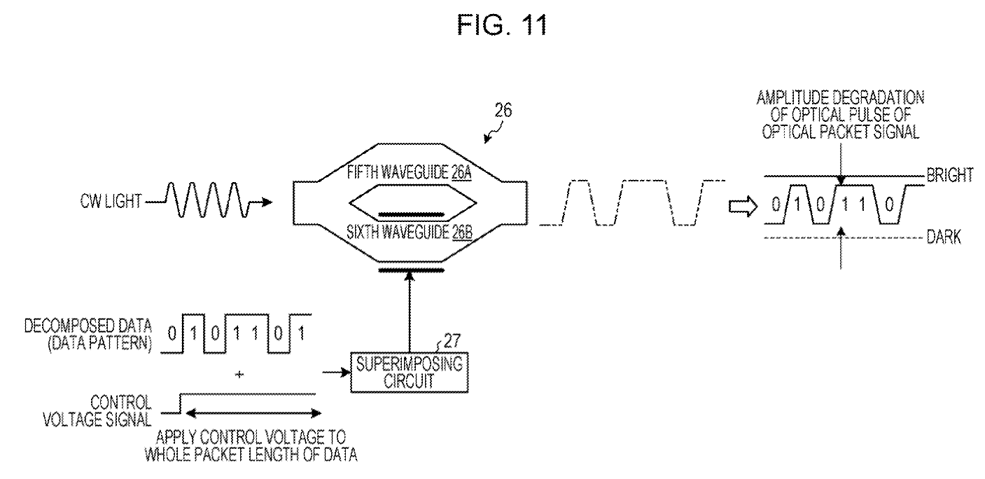

FIG. 10 is an explanatory diagram that illustrates one example of a configuration of an MDL 200 of the second embodiment, and FIG. 11 is an explanatory diagram that illustrates one example of a configuration of an optical modulator 26.

The same reference characters will be given to the same configurations as the MDL 20 of the first embodiment, and descriptions of the same configurations and operations will not be made.

The MDL 200 illustrated in FIG. 10 has a superimposing circuit 27 and the optical modulator 26 in addition to the LD 21, the E/O circuit 22, and the shaping circuit 24.

The superimposing circuit 27 superimposes the decomposed data from the E/O circuit 22 and the control voltage signal from the shaping circuit 24 together and inputs the superimposed signal to the optical modulator 26.

The optical modulator 26 has a fifth waveguide 26A and a sixth waveguide 26B and performs optical branching of the CW light from the LD 21 into the fifth waveguide 26A and the sixth waveguide 26B.

The fifth waveguide 26A transmits the CW light resulting from the optical branching.

The sixth waveguide 26B applies the superimposed signal to the CW light resulting from the optical branching and outputs the optical packet signal whose optical phase has been adjusted.

The optical modulator 26 combines the CW light as an output of the fifth waveguide 26A and the optical packet signal with the adjusted optical phase as an output of the sixth waveguide 26B and outputs the optical packet signal in which an optical phase interference occurs.

As a result, as illustrated in FIG. 11, the steepness of the slopes of Tr and Tf of the optical signal wave of the optical packet signal is reduced.

As a result, the steepness of the slopes of Tr and Tf of the optical signal wave in the optical packet signal is reduced, and the phase modulation of the optical packet signal may thus be reduced.

While an E/O converter and an optical waveform shaper are not provided separately, the optical modulator 26 of the second embodiment performs the optical branching of the CW light from the LD 21 into the fifth waveguide 26A and the sixth waveguide 26B.

The optical modulator 26 applies the superimposed signal for superimposing the control voltage signal and the decomposed data to the CW light that passes through the sixth waveguide 26B and outputs the optical packet signal whose optical phase has been adjusted.

The optical modulator 26 combines the CW light as the output of the fifth waveguide 26A and the optical packet signal with the adjusted optical phase as the output of the sixth waveguide 26B and outputs the optical packet signal in which an optical phase interference occurs.

As a result, the steepness of the slopes of Tr and Tf of the optical signal wave in the optical packet signal is reduced, and the phase modulation of the optical packet signal may thus be reduced.

In the second embodiment, the control voltage signal is superimposed on all the decomposed data (data pattern). Accordingly, the optical phase difference in the original data pattern is changed from 0°→180° or 180°→0°.

Thus, “0” and “1” of the generated optical packet signal are not turning on and turning off but becomes magnitude changes in the light intensity due to degradation of the amplitude of the optical packet signal (extinction ratio degradation of an optical signal).

Accordingly, because it is possible that the transmission distance and SN strength degrade, application of this embodiment is suitable for short distance transmission.

The control voltage signal applied to the optical waveform shaper 25 in the above embodiment adjusts the optical phase of the optical packet signal by voltage control. However, embodiments are not limited to the voltage control, but the optical phase of the optical packet signal may be adjusted by current control or temperature control, for example.

Further, the configuration elements of the sections illustrated in the drawings do not necessarily have to be physically configured as illustrated in the drawings.

That is, specific modes of distribution and integration of the sections are not limited to the modes in the drawings. All or a portion thereof may be configured by functionally or physically distributing or integrating those by any set in accordance with various kinds of loads, use situations, and so forth.

In addition, all or any portion of various kinds of circuits provided in the devices may be executed on a central processing unit (CPU), a digital signal processor (DSP), an integrated circuit (IC), a field programmable gate array (FPGA), and so forth. In addition, a plurality of various kinds of circuits may be integrated into one circuit, and all or any portion thereof may be executed on a central processing unit (CPU), a digital signal processor (DSP), an integrated circuit (IC), a field programmable gate array (FPGA), and so forth.

Further, all or any portion of various kinds of circuits may be executed on a program that is analyzed and executed by a CPU or the like or on hardware by wired logic.

Areas that store various kinds of information may be configured with a read only memory (ROM) and random access memories (RAM) such as a synchronous dynamic random access memory (SDRAM), a magnetoresistive random access memory (MRAM), and non-volatile random access memory (NVRAM), for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a first optical modulator configured to modulate, based on a packet signal for each of packets, input light into an optical packet signal and to output an optical packet signal for each of the packets;
a generation circuit configured to generate an adjustment signal that adjusts slopes of a rise and a fall of a waveform of the optical packet signal; and
a second optical modulator configured to modulate the optical packet signal from the first optical modulator and adjust, based on the adjustment signal, the slopes of the rise and the fall of the waveform of the optical packet signal.

2. The transmission device according to claim 1, wherein
the second optical modulator is configured to
have a first waveguide and a second waveguide,
branch the optical packet signal from the first optical modulator into the first waveguide and the second waveguide,
adjust an optical phase of the optical packet signal that passes through the second waveguide based on the adjustment signal, and
combine the optical packet signal whose optical phase has been adjusted and the optical packet signal that passes through the first waveguide.

3. The transmission device according to claim 2, wherein
the second optical modulator is configured to adjust the optical phase of the optical packet signal by performing voltage control of the optical packet signal that passes through the second waveguide based on the adjustment signal that is related to the voltage control.

4. The transmission device according to claim 2, wherein
the second optical modulator is configured to adjust, based on the adjustment signal that is related to current control, the optical phase of the optical packet signal by performing the current control of the optical packet signal that passes through the second waveguide.

5. The transmission device according to claim 2, wherein
the second optical modulator is configured to adjust, based on the adjustment signal that is related to temperature control, the optical phase of the optical packet signal by performing the temperature control of the optical packet signal that passes through the second waveguide.

6. The transmission device according to claim 1, further comprising:
an optical combiner configured to output combined output of the optical packet signal to a wavelength multiplexing line; and
a division circuit configured to divide the packet signal into time division packets corresponding to wavelengths in the wavelength multiplexing line, wherein
the generation circuit is configured to generate the adjustment signal for each of the wavelength, and
the second optical modulator is configured to adjust, based on the adjustment signal that is related to the wavelength of the optical packet signal that results from the optical conversion, the slopes of the rise and the fall of the waveform in the optical packet signal.

7. The transmission device according to claim 1, further comprising:
an extraction circuit configured to extract destination information from the packet signal; and
an acquisition circuit configured to acquire an adjustment value that corresponds to the extracted destination information, wherein
the generation circuit is configured to generate the adjustment signal that is related to the acquired adjustment value.

8. The transmission device according to claim 7, wherein
the extraction circuit is configured to extract signal-length information related to the packet signal from the packet signal, and
the generation circuit is configured to generate an adjustment time that corresponds to the extracted signal-length information and the adjustment signal that is related to the acquired adjustment value.

9. A phase adjustment method comprising:
outputting an optical packet signal that is modulated based on a packet signal;
receiving an input of the optical packet signal to adjust slopes of a rise and a fall of a waveform of the optical packet signal; and
generating an adjustment signal that adjusts, in response to a destination of the packet signal, the slopes of the rise and the fall of the waveform of the optical packet signal in response to a destination of the packet signal.

10. A transmission device comprising:
an optical modulator configured to modulate, based on a superimposed signal, input light and output an optical packet signal
a generation circuit configured to input a packet signal and generate an adjustment signal that adjusts, in response to a destination of the packet signal, slopes of a rise and a fall of a waveform of the optical packet signal;
a superimposing circuit configured to superimpose the adjustment signal on the packet signal and output the superimposed signal.
